(19) United States
(12) Patent Application Publication
(10) Pub. No.: US 2017/0109335 A1
(43) Pub. Date: Apr. 20, 2017

(54) AUTHORING VISUAL REPRESENTATIONS FOR TEXT-BASED DOCUMENTS

(71) Applicant: Microsoft Technology Licensing, LLC, Redmond, WA (US)

(72) Inventors: Bongshin Lee, Issaquah, WA (US); Timothy Dwyer, Melbourne (AU); Nathalie Henry Riche, Issaquah, WA (US)

(21) Appl. No.: 14/945,869

(22) Filed: Nov. 19, 2015

Related U.S. Application Data
(60) Provisional application No. 62/242,740, filed on Oct. 16, 2015.

(51) Int. Cl. G06F 17/24; G06F 3/0482; G06F 17/22; G06F 17/21; G06F 17/27; G06F 3/0484

(52) U.S. Cl. CPC G06F 17/241; G06F 17/2705; G06F 3/04842; G06F 17/2264; G06F 17/218; G06F 17/274; G06F 3/0482

(57) ABSTRACT

Techniques for authoring visual representations for text-based documents are described herein. In some examples, the techniques utilize Natural Language Processing (NLP) to process text within the document. Based on the NLP, a user can work interactively with the document in order to create visual representations that represent the text in the document. By allowing the user to work interactively with the document based on NLP, the techniques can provide the user with the ability to generate representations of particular concepts of the document.

### RELATED APPLICATIONS

This application claims the benefit of U.S. Provisional Application No. 62/242,740, filed Oct. 16, 2015, the entire contents of which are incorporated herein by reference.

### BACKGROUND

Text documents often include complex information that can be difficult for an individual to quickly read and understand. These documents can include legal documents, financial reports, scientific papers, medical journal articles, and so on. As such, individuals often summarize core concepts of these documents by formulating brief overviews, creating graphs, drawing pictures, etc. However, these manual processes are often time consuming and do not accurately reflect the core concepts of the documents.

### SUMMARY

The techniques and constructs discussed herein facilitate authoring visual representations for text-based documents. In some examples, the techniques can include receiving a document that includes text and processing the document using natural language processing techniques. A user interface can provide a document area to present the document and an authoring area to present visual representations for the document. A selection of a portion of the text presented in the document area of the user interface can be received. Based on the natural language processing techniques, a visual representation for the portion of the text can be generated. The representation can be provided for presentation in the authoring area of the user interface. In some examples, a selection of another portion of the text can be received. Based on the natural language processing techniques, another visual representation for the other portion of the text can be generated. The other visual representation can be provided for presentation in the authoring area of the user interface. In various examples, an association between the visual representation and the other visual representation can be created.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, can refer to system(s), method(s), computer-readable instructions, module(s), algorithms, hardware logic, and/or operation(s) as permitted by the context described above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a block diagram depicting an example environment in which visual representations can be authored for text-based documents.

FIG. 2 is a block diagram depicting example details of computing device(s) of the service provider from FIG. 1.

FIGS. 3A-3D illustrate example graphical user interfaces for authoring visual representations for a document.

FIG. 4 illustrates an example graphical user interface providing a list of text candidates.

FIG. 5 illustrates an example GUI that presents a visual representation of a table.

FIG. 6 illustrates an example process of creating a node graph based on natural language processing.

FIG. 7 illustrates an example node graph for a document.

FIG. 8 is a flow diagram of an example process for authoring a visual representation for a document.

FIG. 9 is a flow diagram of an example process for associating visual representations.

FIG. 10 is a flow diagram of an example process for merging visual representations.

### DETAILED DESCRIPTION

This disclosure is directed to techniques for authoring visual representations for text-based documents. In some examples, the techniques utilize Natural Language Processing (NLP) to process text within the document. Based on the NLP, a user can work interactively with the document in order to create visual representations that represent the text in the document. By allowing the user to work interactively with the document leveraging NLP, the techniques described herein can provide the user with the ability to quickly and/or efficiently generate representations of concepts of the document (e.g., core concepts or other concepts).

In some examples of the techniques described herein, a system can provide a user device with a user interface that includes various tools for creating visual representations. The user interface can include a document area (i.e., first section) to present a document and an authoring area (i.e., second section) to display visual representations for text within the document. The user can select text (e.g., word or phrase) within the document in the document area and create a visual representation for the selected text for display in the authoring area. For instance, a user can select text in the document area and drag the text to the authoring area to create a visual representation. The visual representation can be linked to the selected text. The link can be indicated visually in the document area (e.g., by annotating text) and/or the authoring area.

In some instances, a user can select text in the document area and create a visual representation for other text in the document that is related to the selected text. To illustrate, in response to selecting a word or phrase in the document area, a list of text candidates (e.g., other words or phrases in the document) can be presented that are related to the word or phrase. The list of text candidates can be based on processing the document using NLP. For example, the list can include text that is linked to the selected text through information that is output from the NLP, such as a parse tree, entity information (e.g., co-reference chains), relational phrase information, and so on. Such information that is output from the NLP can indicate relationships between words and/or phrases within the document. To illustrate, a parse tree can describe relationships between words or phrases within a sentence, while entity information can indicate relationships between entities of different sentences. In some instances, the information that is output from the NLP can be processed to form a node graph that describes various types of relationships within the document, such as relationships between entities in the document, relationships between words of a sentence, relationships between words or phrases of different sentences, and so on. The node graph can be used to generate text candidates. In any event, the user can select a candidate from the list of text candidates and a corresponding visual representation for the candidate can be presented in the authoring area of the user interface.

In some examples, a visual representation can include a text box that contains selected text from a document. For instance, a visual representation can include text that is selected by a user from a first sentence and/or text from second sentence (e.g., text from one paragraph that states “hybrid cars are being used more frequently” and text from another paragraph that states “in 2009 hybrid car purchases increased 15%”). Additionally, or alternatively, a visual representation can include a graphical representation of text in a document. For instance, a visual representation can include a graph representing correlations between different portions of text (e.g., a graph illustrating stock price over time for text that identifies stock prices at various years). Further, a visual representation can include an image for selected text (e.g., an image of a car for the term “car”). Moreover, a visual representation can include text that is input by a user. Additionally, or alternatively, a visual representation can include a drawing or sketch that a user has provided (e.g., by drawing with a stylus in a canvas area or the authoring area). In yet other examples, visual representations can include other types of content, such as videos, audio, webpages, documents, and so on.

In some examples, a user can link visual representations to each other. This can provide further visual context of a document. For instance, the user can connect visual representations to each other with visual indicators that indicate associations between the visual representations. A visual indicator can be graphically illustrated within the authoring area of the user interface using lines, arrows, or other graphical representations. The authoring area can allow a user to link any number of visual representations and/or link visual representations in any arrangement (e.g., creating groups of visual representations, creating sub-elements, etc.). The user can label or annotate links between visual representations to indicate relationships between portions of text.

In many instances, the techniques described herein enable users to generate visual representations for text-based documents. A visual representation can represent particular concepts, ideas, and so on of a document. This can assist users in understanding the content of the document. In some instances, the visual representations can be useful for understanding documents that are relatively complex and/or technical, such as legal documents, financial reports, scientific papers, medical journal articles, and so on. Further, by enabling a user to interactively generate the visual representations (e.g., through a user interface), information that accurately depicts the underlying source text can be generated. Moreover, by using NLP, the techniques described herein can intelligently identify text that is related throughout a document and create visual representations for those relations. In some instances, related text can be visually annotated with highlighting, icons, links, suggestion boxes, and so on.

The techniques described herein can be implemented in a variety of contexts. For example, the techniques can be implemented using any number of computing devices and/or environments. As one example, a remote resource (e.g., server) can provide backend functionality to a client device that interfaces with a user. To illustrate, the client device can use a browser or other network application to interface with processing performed by the remote service. As another example, the techniques can be implemented through an application running on a client device, such as a portable document format (PDF) reader/editor, a word processor application (e.g., Microsoft Word®, Google Documents®, etc.), a spreadsheet application (e.g., Microsoft Excel®, Google Sheets®, etc.), an email application, or any other application that presents text.

### Illustrative Environment

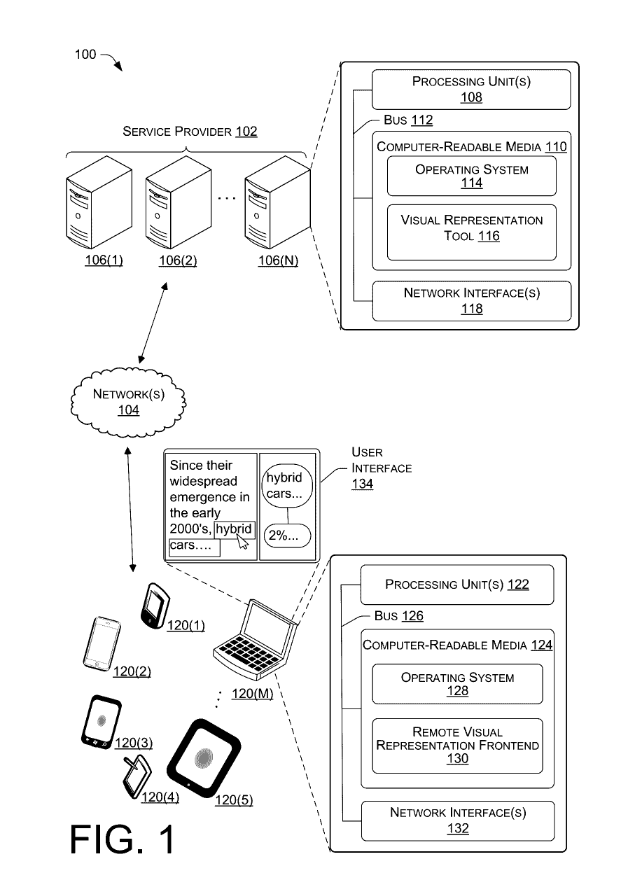

FIG. 1 shows an example environment 100 in which visual representations can be authored for text-based documents. In some examples, the various devices and/or components of environment 100 include a service provider 102 that can communicate with external devices via one or more networks 104. For example, network(s) 104 can include public networks such as the Internet, private networks, such as an institutional and/or personal intranet, or some combination of private and public networks. Network(s) 104 can also include any type of wired and/or wireless network, including but not limited to local area networks (LANs), wide area networks (WANs), satellite networks, cable networks, Wi-Fi networks, WiMax networks, mobile communications networks (e.g., 3G, 4G, and so forth), or any combination thereof. Network(s) 104 can utilize communications protocols, including packet-based and/or datagram-based protocols, such as internet protocol (IP), transmission control protocol (TCP), user datagram protocol (UDP), or other types of protocols. Moreover, network(s) 104 can also include a number of devices that facilitate network communications and/or form a hardware basis for the networks, such as switches, routers, gateways, access points, firewalls, base stations, repeaters, backbone devices, and the like.

In some examples, network(s) 104 can further include devices that enable connection to a wireless network, such as a wireless access point (WAP). For instance, support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various examples, service provider 102 can include devices 106(1)-106(N). Examples support scenarios where device(s) 106 can include one or more computing devices that operate in a cluster or other grouped configuration to share resources, balance load, increase performance, provide fail-over support or redundancy, or for other purposes. Device(s) 106 can belong to a variety of categories or classes of devices such as traditional server-type devices, desktop computer-type devices, mobile devices, special purpose-type devices, embedded-type devices, and/or wearable-type devices. Thus, although illustrated as server computers, device(s) 106 can include a diverse variety of device types and are not limited to a particular type of device. Device(s) 106 can represent, but are not limited to, desktop computers, server computers, web-server computers, personal computers, mobile computers, laptop computers, tablet computers, thin clients, terminals, personal data assistants (PDAs), work stations, integrated components for inclusion in a computing device, or any other sort of computing device.

Device(s) 106 can include any type of computing device having one or more processing unit(s) 108 operably connected to computer-readable media 110, such as via a bus 112, which in some instances can include one or more of a system bus, a data bus, an address bus, a PCI bus, a Mini-PCI bus, and any variety of local, peripheral, and/or independent buses. Executable instructions stored on computer-readable media 110 can include, for example, an operating system 114, a visual representation tool 116, and other modules, programs, or applications that are loadable and executable by processing units(s) 108. Alternatively, or in addition, the functionality described herein can be performed, at least in part, by one or more hardware logic components, such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Device(s) 106 can also include one or more network interfaces 118 to enable communications between computing device(s) 106 and other networked devices, such as client computing device(s) 120, or other devices over network(s) 104. Such network interface(s) 118 can include one or more network interface controllers (NICs) or other types of transceiver devices to send and receive communications over a network. For simplicity, other components are omitted from the illustrated device(s) 106.

Other devices involved in authoring visual notes to a text can include client computing devices 120(1)-120(M). Device(s) 120 can belong to a variety of categories or classes of devices, such as client-type devices, desktop computer-type devices, mobile devices, special purpose-type devices, embedded-type devices, and/or wearable-type devices. Thus, although illustrated as mobile computing devices, which can have less computing resources than device(s) 106, device(s) 120 can include a diverse variety of device types and are not limited to any particular type of device. Device(s) 120 can include, but are not limited to, computer navigation type client computing devices 120(1) such as satellite-based navigation systems including global positioning system (GPS) devices and other satellite-based navigation system devices, telecommunication devices such as mobile phone 120(2), mobile phone tablet hybrid 120(3), personal data assistants (PDAs) 120(4), tablet computers 120(5), laptop computers, such as 120(N), other mobile computers, wearable computers, desktop computers, personal computers, network-enabled televisions, thin clients, terminals, work stations, integrated components for inclusion in a computing device, or any other sort of computing device.

Device(s) 120 can represent any type of computing device having one or more processing unit(s) 122 operably connected to computer-readable media 124, such as via a bus 126, which in some instances can include one or more of a system bus, a data bus, an address bus, a PCI bus, a Mini-PCI bus, and any variety of local, peripheral, and/or independent buses. Processing unit(s) 122 can include a central processing unit (CPU), a graphics processing unit (GPU), an accelerator (e.g., a field-programmable gate array (FPGA) type accelerator, a digital signal processor (DSP) type accelerator, or any internal or external accelerator), and so on.

Executable instructions stored on computer-readable media 124 can include, for example, an operating system 128, a remote visual representation frontend 130, and other modules, programs, or applications that are loadable and executable by processing units(s) 122. Alternatively, or in addition, the functionally described herein can be performed, at least in part, by one or more hardware logic components such as accelerators. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. For example, an accelerator can represent a hybrid device, such as one from ZYLEX or ALTERA that includes a CPU course embedded in an FPGA fabric.

Device(s) 120 can also include one or more network interfaces 132 to enable communications between device(s) 120 and other networked devices, such as other client computing device(s) 120 or device(s) 106 over network(s) 104. Such network interface(s) 132 can include one or more network interface controllers (NICs) or other types of transceiver devices to send and receive communications over a network.

In some examples, the visual representation tool 116 can communicate, or link, via network(s) 104 with remote visual representation frontend 130 to provide functionalities for the device(s) 120 to facilitate authoring of visual representations for documents. For example, visual representation tool 116 can perform processing to provide user interface 134 to be output via device(s) 120 (e.g., send data to remote visual representation frontend 130 (via network(s) 104) to present user interface 134). Remote visual representation frontend 130 can display user interface 134 via a display of device(s) 120 and/or interface with the user (e.g., receive user input, output content, etc.). As illustrated, and discussed in detail hereafter, user interface 134 can include a document area (left side) to present text of a document and an authoring area (right side) to present visual representations for the document. In some examples, visual representation tool 116 can be implemented via a browser environment and/or a software application, where device(s) 120 displays user interface 134 and service provider 102 provides backend processing. Alternatively, or additionally, visual representation tool 116 can be implemented at device(s) 120, such as in a client application (e.g., PDF reader, word processor, etc.). Here, visual representation tool 116 (or any number of components of visual representation tool 116) can be provided within computer-readable media 124 of device(s) 120. As such, in some instances functionality of visual representation tool 116 can be performed locally, rather than over network(s) 104.

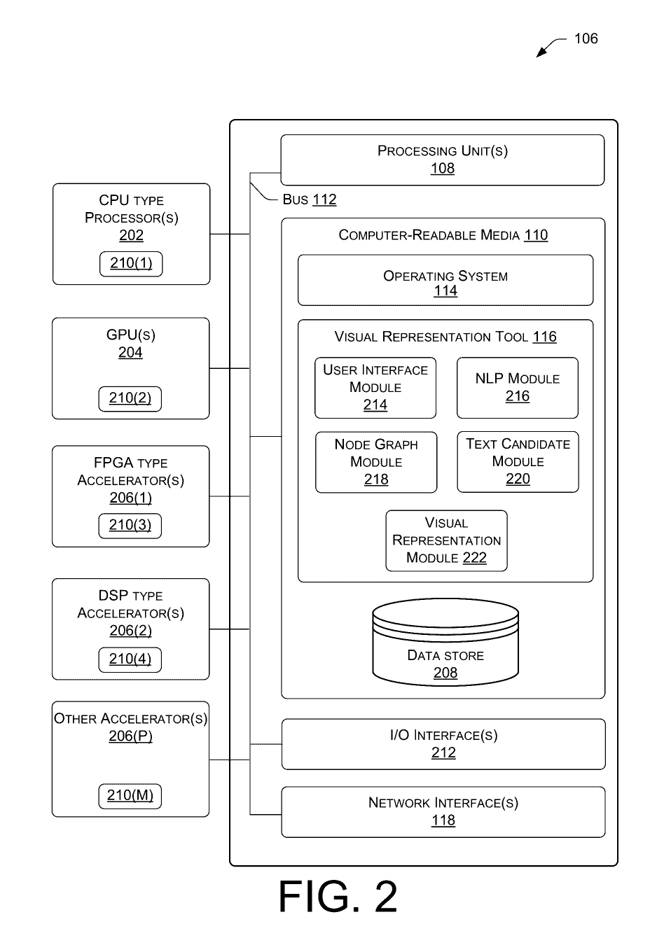

FIG. 2 is a block diagram depicting example details of computing device(s) 106 of the service provider 102 from FIG. 1. Device(s) 106 can include processing unit(s) 108, which can represent, for example, a CPU-type processing unit, a GPU type processing unit, an FPGA type processing unit, a DSP type processing unit, or other hardware logic components that can, in some instances, be driven by a CPU. For example, and without limitation, illustrative types of hardware logic components that can be used include Application-Specific Integrated Circuits (ASICs), Application-Specific Standard Products (ASSPs), System-on-a-chip systems (SOCs), Complex Programmable Logic Devices (CPLDs), etc.

In the illustrated example, computer-readable media 110 can store instructions executable by processing unit(s) 108. Computer-readable media 110 can also store instructions executable by CPU-type processor 202, GPU 204, and/or an accelerator 206, such as an FPGA type accelerator 206(1), a DSP type accelerator 206(2), or any internal or external accelerator 206(P). In various examples at least one CPU type processor 202, GPU 204, and/or accelerator 206 is incorporated in device(s) 106, while in some examples one or more of CPU type processor 202, GPU 204, and/or accelerator 206 are external to device(s) 106, as illustrated in FIG. 2. Executable instructions stored on computer-readable media 110 can include, for example, operating system 114, visual representation tool 116, and/or other modules, programs, or applications that are loadable and executable by processing units(s) 108, CPU type processor 202, GPU 204, and/or accelerator 206.

In the illustrated embodiment, computer-readable media 110 also includes a data store 208. In some examples, data store 208 can include data storage, such as a database, data warehouse, or other type of structured or unstructured data storage. In some examples, data store 208 can include a relational database with one or more tables, indices, stored procedures, and so forth to enable data access. Data store 208 can store data for the operations of processes, applications, components, and/or modules stored in computer-readable media 110 and/or executed by processing units(s) 108, CPU type processor 202, GPU 204, and/or accelerator 206. In some examples, data store 208 can store documents to be processed by visual representation tool 116. A document can include any type of data or information. A document can include text, images, or other types of content. Example documents include legal documents, financial reports, scientific papers, journal articles (e.g., media journal articles), news articles, magazine articles, social media content, emails, patents, electronic books (e-Books), and so on. Additionally, or alternatively, some or all of the above-referenced data can be stored on separate memories, such as a memory 210(1) on board CPU type processor 202, memory 210(2) on board GPU 204, memory 210(3) on board FPGA type accelerator 206(1), memory 210(4) on board DSP type accelerator 206(2), and/or memory 210(M) on board another accelerator 206(P).

Device(s) 106 can further include one or more input/output (I/O) interfaces 212 to allow device(s) 106 to communicate with input/output devices, such as user input devices including peripheral input devices (e.g., a keyboard, a mouse, a pen, a game controller, a voice input device, a touch input device, a gestural input device, and the like) and/or output devices including peripheral output devices (e.g., a display, a printer, audio speakers, a haptic output, and the like). In addition, in device(s) 106, network interface(s) 118 can represent, for example, network interface controllers (NICs) or other types of transceiver devices to send and receive communications over a network.

In the illustrated example, computer-readable media 110 can include visual representation tool 116. Visual representation tool 116 can include one or more modules and/or APIs, which are illustrated as blocks 214, 216, 218, 220, and 222, although this is just an example, and the number can vary higher or lower. Functionality associated with blocks 214, 216, 218, 220, and 222 can be combined to be performed by a fewer number of modules and/or APIs, or it can be split and performed by a larger number of modules and/or APIs.

Block 214 can represent a user interface module with logic to provide a user interface. For instance, device(s) 106 can execute user interface module 214 to provide a user interface (e.g., user interface 134 of FIG. 1) to a computing device, such as one of computing device(s) 120 from FIG. 1. In one example, providing a user interface can include sending data associated with the user interface to a computing device via a network. In another example, providing a user interface can include displaying the user interface via a computing device. The user interface can include various tools for creating visual representations for a document. The user interface can include a first section (i.e., document area) to present a document and a second section (i.e., authoring area) for authoring visual representations. In one example, a user can create a visual representation by selecting a portion of text from the document and dragging the portion of text to the authoring area. In another example, the user can create the visual representation by merely selecting a portion of text from the document. In yet another example, and as discussed below with regard to text candidate module 220, the user can select text from a list of text candidates that text candidate module 220 provides for text that has been selected by the user.

Block 216 can represent a natural language processing (NLP) module with logic to process a document using NLP techniques. For instance, device 200 can execute NLP module 216 to parse text into tokens (e.g., each token representing a word or phrase) and/or use the tokens to generate parse trees, entity information, relational phrase information, and so on. A parse tree can include a hierarchical tree that represents the syntactic structure of a string (e.g., sentence within text) according to a grammar. In one example, a parse tree can indicate relationships between one or more words or phrases within a sentence of text. For instance, relationships can include dependencies between one or more words or phrases. A dependency of a word or phrase to another word or phrase can be represented in a parse tree with a node for the word or phrase being connected to the other word or phrase. A dependency can be labeled by type. In some instances, a dependency can include a compound dependency indicating words or phrases that are connected together by a “compound” in a sentence. A compound dependency can be composed of an indirect link in a parse tree (e.g., a node that is connected to another node via an intermediate node).

Entity information can be generated by recognizing entities within text (e.g., using named entity recognition (NER)) and/or recognizing co-reference chains of entities within the text. An entity can include any noun, such as a name, location, quantity, object, organization, time, money, percentage, etc. The entity information can identify an entity and/or a type/class of the entity (e.g., person, location, quantity, organization, time, etc.). Further, the entity information can indicate that an entity identified in one portion of text is related to an entity identified in another portion of text. For instances, a co-reference chain can indicate that a sentence of a particular paragraph references “the Federal Reserve” and a sentence of another paragraph references “the Federal Reserve.” In some instances, NLP techniques (e.g., NER) can be used to identify entities that are explicitly mentioned in the text. Additionally, or alternatively, NLP techniques (e.g., co-reference chain recognition) can be used to identify pronouns (e.g., “it,” “they,” “he,” “she,” etc.) as corresponding to particular entities.

Meanwhile, relational phrase information can indicate a relationship for a subject, verb, object, and/or other elements in text that can be related. In some instances, a subject, verb, and object are referred to as a triple. Such subject/verb/object triples can indicate relationships between parts of a sentence such that they tie together co-reference chains. In this way, the combination of subject/verb/object relations and co-reference chains can indicate structure in the document. For example, tying together important, reoccurring noun phrases such as “the Federal Reserve” and “decreasing jobless rate” with a verb such as “predicts.”

Block 218 can represent a node graph module with logic to generate a node graph (i.e., node-link graph) for a document. For instance, device(s) 106 can execute node graph module 218 to generate a node graph for a document (e.g., semantic graph) based on information that is output by NLP module 216 for the document. The node graph can indicate relationships between one or more words, phrases, sentences, paragraphs, pages, section, and so on, within the document. To generate a node graph, node graph module 218 can combine parse trees, entity information, relational phrase information, or any other information that is output by NLP module 216 to form nodes and connections between the nodes. In some instances, a node can represent a token that is identified from NLP module 216. Further, in some instances a node can represent a word, phrase, sentence, paragraph, page, section, and so on, of the document. Meanwhile, a connection between nodes can represent a relationship between the nodes. An example node graph is described below in reference to FIG. 7.

In some instances, a node is associated with a particular class. Examples classes of nodes include a sentence class, an entity class, a mention representative class, a mention class, and/or a subject/verb/object class. A sentence node can represent an individual sentence. In some instances, a node graph for a document can include a sentence node for each sentence in the document (e.g., a sentence node can represent an entire sentence). An entity node can represent an entity that is mentioned in a document. In some instances, a node graph for a document can include a node for each entity that is mentioned in the document. A mention representative node can represent a sentence that best describes an entity from among sentences in a document. The sentence that best describes the entity can include the most detail (e.g., most words, most descriptive words, etc.), a definition, and so on, from among sentences that mention the entity. In some instances, a node graph for a document can include a single mention representative node for an entity mentioned in a document. A mention node can represent a sentence that mentions an entity. In some instances, a node graph for a document can include a node for each sentence that mentions an entity. A subject node can represent the subject part of a subject/verb/object triple relation. Similarly, a verb node and an object node can represent the verb part and object part, respectively, of the subject/verb/object relation.

Further, in some instances a relationship (link) between two or more nodes can be associated with a particular class. Example classes of links can include a class for connecting a mention node with a representative mention node of a co-reference chain, a class for connecting sentence nodes with mention nodes (where the mention occurs in that sentence), and a class for connecting subject/verb/object nodes to one another (e.g., subject to verb, verb to object). Additional classes of links can connect parts of subject/verb/object triples with the sentence nodes which contain them. Another class of links can connect sentence nodes to each other in the order they occur in the document (e.g., connect a first sentence node associated with a first sentence to a second sentence node associated with a second sentence where the second sentence is directly after the first sentence). In addition, a parse tree for text can provide dependency relations (links) between individual tokens (e.g., words) in the text. This can provide additional classes of links. For example, nodes can be connected based on conjunctions, prepositions, and so forth. Non-limiting examples of parse-dependency link types (classes) can be found in the “Stanford Typed Dependencies Manual,” by Marie-Catherine de Marneffe & Christopher D. Manning.

Block 220 can represent a text candidate module with logic to provide text candidates regarding text in a document. For instance, upon a user selecting text of a document, device(s) 106 can execute text candidate module 220 to provide a list of text candidates that are related to the selected text. In some instances, the user can select the text by hovering an input device (e.g., mouse, pen, finger, etc.) over a display screen at a location of the text. In other instances, the user can highlight or otherwise select the text. To generate the list of text candidates, text candidate module 220 can use a node graph and/or any information that is output by NLP module 216. For example, a list of text candidates can include text that is related to a user's selected text based on relationships that are indicated in a node graph, parse tree, entity information, and/or relational phrase information. For instance, after a user selects a word or phrase in a document (which corresponds to a particular node in a node graph for the document), text candidate module 220 can reference the node graph to identify nodes that are related to the particular node in the node graph. Here, text candidate module 220 can traverse the node graph to identify neighboring nodes that are connected to the particular node. To illustrate, if a user selects a term “hybrid car” (which corresponds to an entity node of “hybrid cars” in a node graph), and that entity node is linked to a mention representative node that best represents “hybrid cars” within the document, text candidate module 220 can identify the mention representative node as a text candidate. Here, the sentence associated with the mention representative node can be presented as the text candidate for the user to select. In some instances, any amount of text associated with an identified node in a node graph can be provided as a text candidate. To illustrate, if (in response to selecting text) a node is identified in a node graph that represents a subject, verb, and object, the entire sentence that is associated the subject, verb, and object can be presented as the text candidate.

As one example process of identifying text candidates, text candidate module 220 can start at an initial node (in a node graph) that represents text that is selected by a user. Here, text candidate module 220 can examine a parse tree for the initial node (that is included as part of the node graph) to identify nodes that are connected to that initial node in the parse tree. The parse tree can include leaf nodes (end nodes that do not have children) and non-leaf or internal nodes (nodes have children nodes (e.g., nodes that are connected to lower level nodes)). If the initial node (that corresponds to the selected text) is a leaf node, text candidate module 220 can select (as a candidate) a parent node (higher node) to the initial node and/or a sibling node to the initial node (node connected via the parent node). Alternatively, if the initial node is a non-leaf node, text candidate module 220 can select (as candidates) children nodes (nodes that depend from the initial node). In some instances, a sibling node that is not critical in constructing a coherent text snippet (e.g., a determiner or adjectival modifier) can be omitted to create more candidates. If a node identified as a candidate is a part of an SVO, a co-reference chain, and/or a named entity, then the full text associated with the SVO, co-reference chain, and/or named entity can be used as a candidate. In some instances, the above noted example process can be repeated for each node that is identified as a candidate, in order to expand the list of candidates. For instance, text candidate module 220 can find a particular node that is connected to an initial node, and then seek to identify further candidates for the initial node by finding nodes that are connected to the particular node in a same fashion as that described above. In some instances, the example process can be repeated until a whole sentence is included as a candidate, a word length threshold is met, and so on. Upon identifying candidates, text candidate module 220 can present the candidates in an order from shortest to longest, vice versa, or any other order.

Block 222 can represent a visual representation module with logic to generate and/or linking visual representations. For instance, after a user selects a portion of text and/or text from a list of text candidates, device(s) 106 can execute visual representation module 222 to generate a visual representation based on the selection. In an example, a visual representation can include a text box that includes the text from the selection by the user. In another example, a visual representation can include a graphical object that represents the text from the selection by the user. The graphical object can include a chart, graph, and/or table that is generated using selection by the user. In yet another example, the visual representation can include an image representing selected text (e.g., an image of a car for text of “car”). Although many techniques discussed herein describe generating visual representations for textual content, in some instances visual representations can be generated for other types of content, such as images, audio embedded in a document, and so on.

As one example, visual representation module 222 can generate a chart, graph, and/or table by recognizing values that can be graphically presented. To illustrate, visual representation module 222 can identify numerical values within text that is selected by a user and identify data that corresponds to the numerical values. Visual representation module 222 can then generate the chart, graph, and/or table using the numerical values and corresponding data. For instance, in response to a user selecting a sentence that states “In 2009, hybrid car sales were around 20,000, while in 2010 sales increased to 25,000,” visual representation module 222 can identify years 2009 and 2010 and the number of sales for those years (20,000 and 25,000, respectively). Visual representation module 222 can then generate a graph showing the number or sales with respect to years. The graph can be linked to the text from the document. In some instances, such as in cases where a user notices that the values are not accurate, a user can edit a chart, graph, and/or table. Visual representation module 222 can then adjust the underlying association for the data. If, for instance, in the example mentioned above, visual representation module 222 had incorrectly associated 20,000 with the year 2010, the user can edit the graph (or an underlying table of the information) so that 20,000 is associated with the year 2009.

In some instances, visual representation module 222 can provide recommendations for creating a chart, graph, and/or table. For instance, visual representation module 222 can recommend that data that is related to selected text be added to a chart, graph, and/or table. Visual representation module 222 can identify the relation using a node graph and/or any information that is output by NLP module 216. The user can then request that visual representation module 222 add the data to the chart, graph, and/or table. In returning to the example above, where the sentence states “In 2009, hybrid car sales were around 20,000, while in 2010 sales increased to 25,000,” visual representation module 222 can identify another sentence later on in the document that indicates a number of sales of hybrid cars for the year 2014. The other sentence can be highlighted or otherwise presented to the user as a recommendation to add the additional data to the graph.

Visual representation module 222 can present visual representations within an authoring area of a user interface. In some instances, visual representations can be linked together. For instance, a user can touch a visual representation to and/or overlay the visual representation on another visual representation and the two visual representations can be linked. In one example, an indicator (e.g., line, arrow, etc.) can be presented between the visual representations to illustrate the linking Additionally, or alternatively, the indicator can include a label that describes the association (e.g., greater than/less than, in support of (label of “for”), in opposition to (label of “against”), because, in view of, etc.), which can be generated by visual representation module 222 and/or provided by the user. Further, in some instances visual representations can be associated by combining the visual representations into a single visual representation. For example, a user can combine a first chart, graph, and/or table with a second chart, graph, and/or table to form a single combined chart, graph, and/or table. In another example, a larger visual representation can be used to encompass two smaller visual representations that are combined. To illustrate, a first text box that indicates a number of hybrid cars sold for Company A and a second text box that indicates a number of hybrid cars sold for Company B can be presented within a larger visual representation representing a total number of hybrid cars sold.

Although blocks 214-222 are discussed as being provided within device(s) 106, any number of blocks 214-222 can be provided within another device, such as device(s) 120 in FIG. 1. As such, blocks 214-222 can be executed by processing unit(s) 122 to implement local processing.

Computer-readable media 110 and/or 124 (as well as all other computer-readable media described herein) can include computer storage media and/or communication media. Computer storage media can include volatile memory, nonvolatile memory, and/or other persistent and/or auxiliary computer storage media, removable and non-removable computer storage media implemented in any method or technology for storage of information such as computer readable instructions, data structures, program modules, or other data. Computer storage media can include tangible and/or physical forms of media included in a device and/or hardware component that is part of a device or external to a device, including but not limited to random-access memory (RAM), static random-access memory (SRAM), dynamic random-access memory (DRAM), phase change memory (PRAM), read-only memory (ROM), erasable programmable read-only memory (EPROM), electrically erasable programmable read-only memory (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast, communication media can embody computer readable instructions, data structures, program modules, or other data in a modulated data signal, a carrier wave, a propagated signal, per se, or other transmission mechanism. As defined herein, computer storage media does not include communication media.

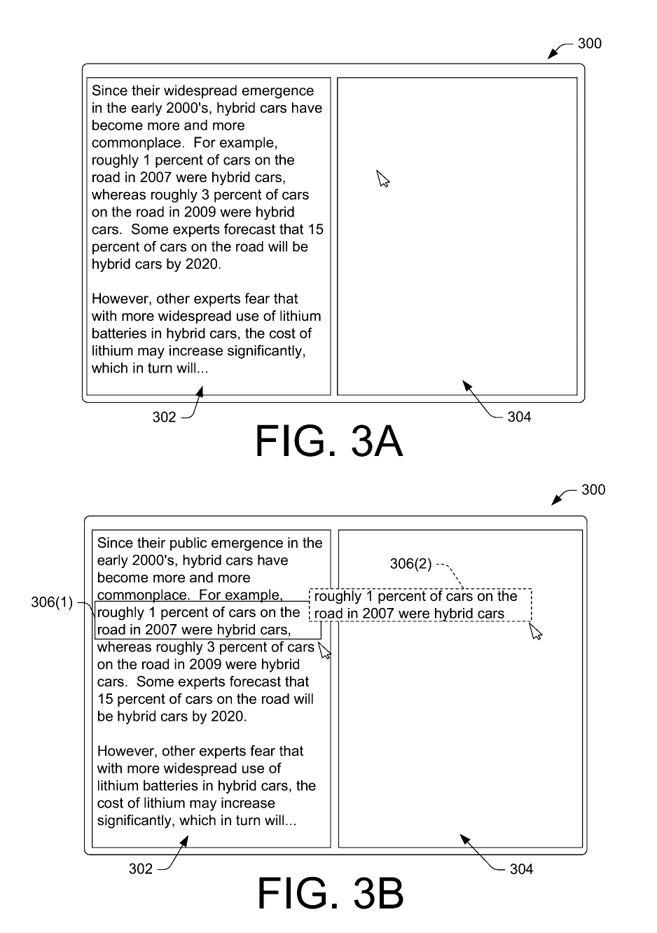

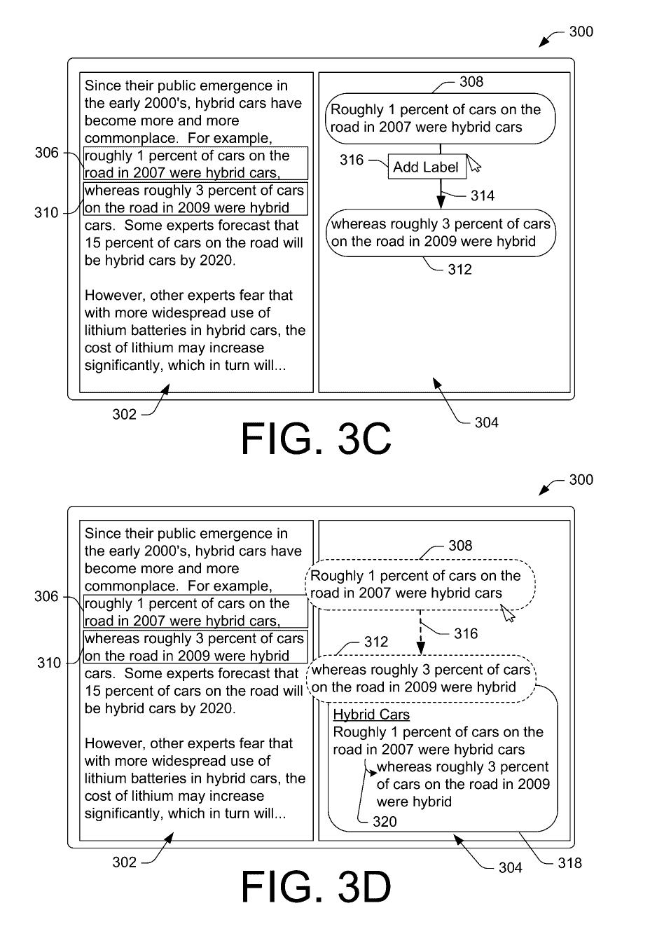

FIGS. 3A-3D illustrate example graphical user interfaces for authoring visual representations for a document.

FIG. 3A illustrates an example graphical user interface (GUI) 300 that includes a document area 302 and an authoring area 304. In some examples, document area 302 can present the information contained in a document, such as text, images, numbers, or other content. In some instances, document area 302 can provide additional tools for navigating the document (e.g., scroll bars, search functions, etc.). Further, document area 302 can allow for interaction using one or more peripheral input/output devices. Document area 302 can further facilitate interaction with the information displayed by allowing editing of text, inputting information (e.g., annotating the text—highlighting, comments, underlining, etc.), formatting of sentences or paragraphs, and so forth. Authoring area 304 can comprise a space (i.e., a canvas) for adding visual representations and/or editing the visual representations. Authoring area 304 can have various tools for adding and/or editing the visual representations. In some instances, GUI 300 is associated with a text-based application, such as a PDF reader/editor, word processor, etc. In other instances, GUI 300 is associated with other types of applications and/or systems.

FIG. 3B illustrates how GUI 300 can allow selection of information contained in document area 302. For instance, document area 302 can facilitate selection of a portion of the text (illustrated as first box 306(1)) using one or more input/output devices. As shown in FIG. 3B, a cursor of an input device has selected text of first box 306(1). In some examples, first box 306 can have various visual indicators that indicate that the portion of the text selected, such as outlining the box, highlighting the box, underlining the box, annotating the text (e.g., highlighting, italics, underlining, showing in a different color, etc.), and so forth. In various examples, GUI 300 can allow text of first box 306(1) to be moved from document area 302 to authoring area 304. For example, a user can “click-and-drag” a copy of text within first box 306(1) from document area 302 over to authoring area 304, as illustrated by first copy box 306(2). Upon dropping first copy box 306(2) in authoring area 304 first visual representation 308 can be created, as illustrated in FIG. 3C. In various examples, upon selection of visual representation 308 in authoring area 304, GUI 300 can present various visual indicators for text of first box 306(1) to illustrate a link, or association, between first box 306(1) and first visual representation 308. For example, text within first box 306(1) can be annotated with highlighting, underlining, italics, a different color, etc.

FIG. 3C illustrates GUI 300 with linked visual representations. Similar to the movement of first box 306(1) from document area 302 to authoring area 304 to create first visual representation 308, GUI 300 can allow the movement of text within second box 310 from document area 302 to authoring area 304 to create second visual representation 312. Authoring area 304 can provide various tools for interacting with first visual representation 308 and/or second visual representation 312. For example, authoring area 304 can allow linking of first visual representation 308 to second visual representation 312 and/or displaying visual link 314 (e.g., indicator) between first visual indicator 308 and second visual indicator 312 once linked. For instance, using an input device, first visual representation 308 can be linked to second visual representation 312 in authoring area 304 by moving an edge of second visual representation 312 over an edge of first visual representation 308 (or vice versa). In some examples, GUI 300 can enable a user to create label 316 for visual link 314. Label 316 can include free-form text and/or a predefined category. This can allow the user to define the relationship between first visual representation 308 and second visual representation 312. In one example, a user can select visual link 314 (e.g., right-click on a mouse, left-click on a mouse, touch input, etc.), and a menu can present an option to “add label” that, when selected, allows visual link 316 to be labeled.

In some examples, after creating first visual representation 308, GUI 300 can provide suggestions, or hints, for creating another visual representation, such as second visual representation 312. For example, based on the text contained in first visual representation 308, GUI 300 can provide a suggestion for second visual representation 312, or any number of additional visual representations, to be linked to first visual representation 308. The suggestion can identify portions of text to create additional visual representations based on the selected text contained in first visual representation 308. The suggestion can be based on output from NLP techniques performed on the document, a node graph for the document, and so on. By providing this suggestion, GUI 300 can assist a user in associating visual representations.

Additionally, or alternatively, in some examples a user can create multiple visual representations from different portions of text and GUI 300 can provide suggestions regarding how to link the multiple visual representations. For instance, after creating first visual representation 308 and second visual representation 312, GUI 300 can provide a suggestion to link first visual representation 308 with second visual representation 312 based on output from NLP techniques for the document, a node graph for the document, and so on. The suggestion can be based on the text for the underlying visual representations being related. As such, a user can be provided with a suggestion to connect visual representations.

Further, although first visual representation 308 is illustrated in FIG. 3C as being located below second visual representation 312, first visual representation 308 and/or second visual representation 312 can be arranged in any manner, such as to a side, on top of, behind, etc. In many instances, a user can manipulate visual representations within authoring area 304 to be located in a particular arrangement.

FIG. 3D illustrates GUI 300 with combined visual representations. In particular, authoring area 304 can allow first visual representation 308 and second visual representation 312 to be combined into main box 318 (e.g., combined visual representation). For example, a user can select first visual representation 308 and second visual representation 312 and move the selected visual representations onto main box 318. Since second visual representation 312 depends from first visual representation 308, such action can cause information of first visual representation 308 and second visual representation 312 to be organized in a particular arrangement, as illustrated with dependency arrow 320 from the text of first visual representation 308 to the text of second visual representation 312. In other examples, visual representations can be arranged differently in main box 318, such as in another type of a tiered, or hierarchal form, or any other form.

Although FIG. 3D illustrates one example of combining visual representations into main box 318, in other examples visual representations can be combined differently. For instance, upon selecting first visual representation 308 and second visual representation 312, a user can right click to request (or by other means request) that the visual representations be combined. Here, main box 318 can be created from the request. Additionally, in some examples a title can be created indicating subject matter discussed or presented in main box 318. To illustrate, NLP techniques can determine an appropriate title for main box 318.

While example visual representations are illustrated in FIGS. 3A-3D with particular shapes, any type of shape and/or graphical representation can be presented. Further, although document area 302 is shown as illustrating textual content, other types of content can be displayed within document area 302 (e.g., pictures, images, icons, graphs, etc.).

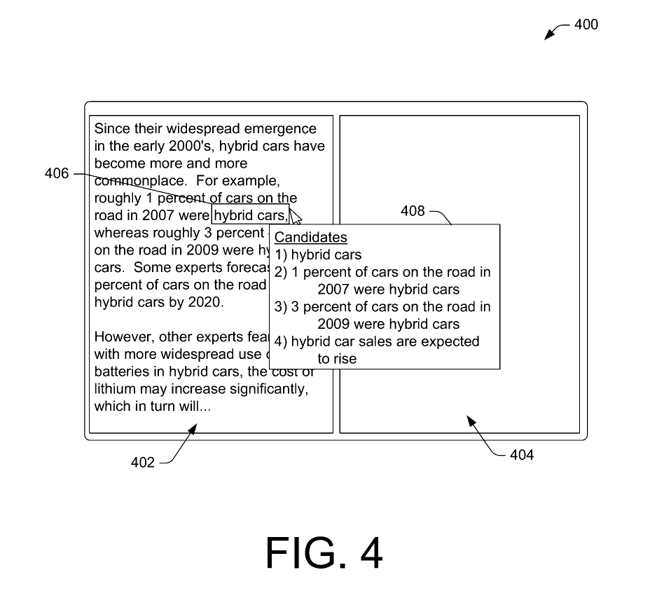

FIG. 4 illustrates an example GUI 400 that presents a list of candidates, such as a list of text candidates. Here, GUI 400 includes document area 402 and authoring area 404. Document area 402 can allow selection of text of first box 406. In response to such selection, GUI 400 can present candidate menu 408 for displaying candidates associated with text of first box 406 (“hybrid cars”). In some examples, text candidate module 220 can determine the candidates for candidate menu 408 based on a node graph for the document and/or any information from processing the document with NLP techniques. In the illustrated example, text candidate menu 408 can present candidates 1-4. In particular, candidates 1, 2, and 3 are linked the “hybrid cars” node through a parse tree for the sentence and/or relational phrase information indicating a subject, verb, and object for the sentence. In addition, candidate 4 is linked to the “hybrid cars” node via a co-reference chain. Here, candidate 4 is from a different paragraph that is not illustrated in FIG. 4. Although illustrated with particular candidates, other types of candidate can be presented, such as the entire sentence, another entire sentence that is linked to the “hybrid cars” node, or any other text that is linked via a node graph or information output by processing the document with NLP. In any event, upon selection of a candidate in candidate menu 408, a corresponding visual representation can be presented in authoring area 404.

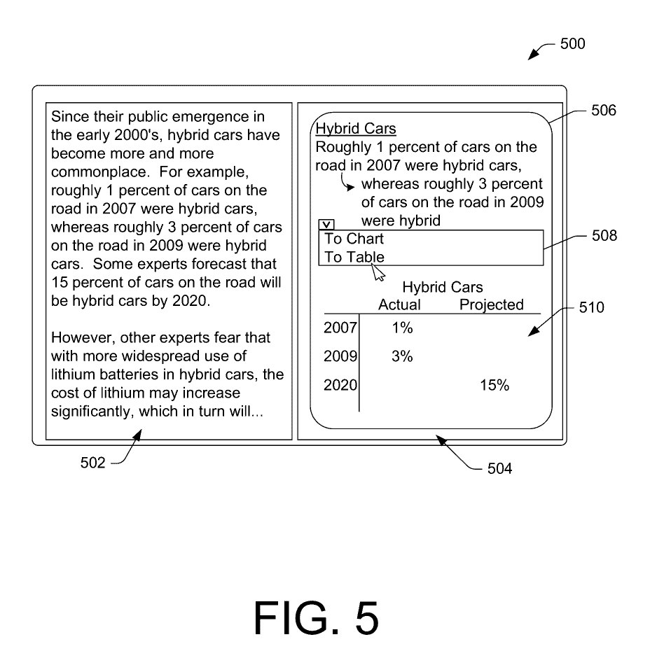

FIG. 5 illustrates an example GUI 500 that presents a visual representation of a table. GUI 500 can include document area 502 and authoring area 504. In this example, a user has combined multiple visual representations to form main box 506 (e.g., visual representation), similar to what occurred in FIG. 3D. Main box 506 can display menu 508, such as a drop down menu, to enable a user to create a chart or graph for information that is within main box 506. In the example, a user has selected to view a table and main box 506 is updated to show table 510. Here, numerical values within text of main box 506 are identified and correlated to each other. Such correlation can be based on the type of data. In this example, “1 percent” and “3 percent” are identified as percentages, while “2007” and “2009” are identified as years. Further, since both text segments include a percentage and a year, the percentages and years are correlated to form data for table 510. In some instances, text (e.g., values) can be correlated based on the underlying parse tree for that text. For example, “1 percent” can be correlated to “2007,” due to a node in a parse tree for the sentence having the “1 percent” node closer to the “2007” node than the “2009” node. That is, the “1 percent” node is a nearer neighbor to the “2007” node than the “2009” node in the parse tree for the sentence. In some instances, ambiguities between correlations can be resolved through user interaction. If, for example, the “2009” node is identified as being a second best correlation for the “1 percent” node, and an accuracy threshold is not met for a correlation between the “1 percent” node and the “2007” node, then a menu can be presented (e.g., drop-down menu) next to “2007” in table 510 to allow a user to change the correlation so that “2009” is associated with “1 percent” instead of “2007.” This can allow a user to help resolve ambiguities and/or correct mistakes.

In FIG. 5, table 510 is automatically updated with data from additional text (e.g., different than that of main box 506) that is also related to years and percentages (e.g., projected percentage of cars in 2020). Such update can be based on NLP techniques that have identified similar data types in the additional text. In some instances, this additional data can be presented to a user before it is entered into table 510. Alternatively, or additionally, this additional data can be indicated differently to illustrate that it originates from different text than that of main box 506, such as in a different color, underlined, italics, bolded, etc. Although a table is illustrated in FIG. 5, any type of graphical representation can be presented, such as a pie chart, line graph, bar chart, and so forth.

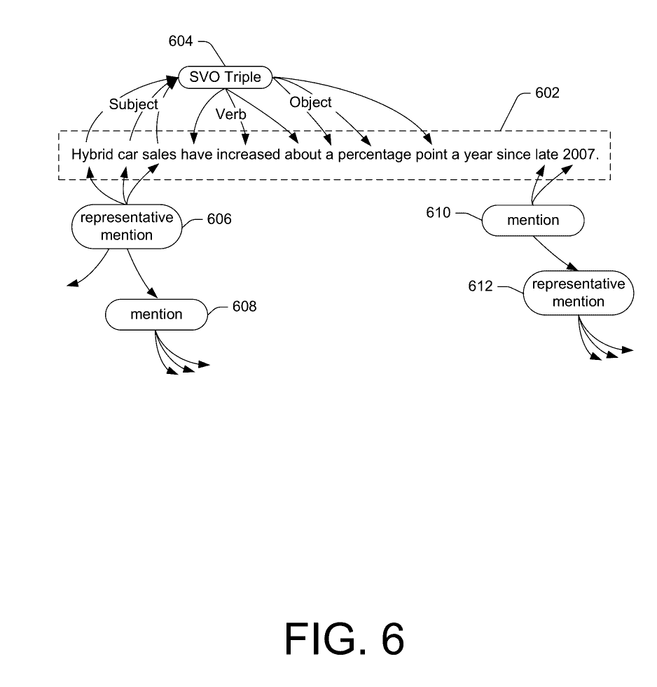

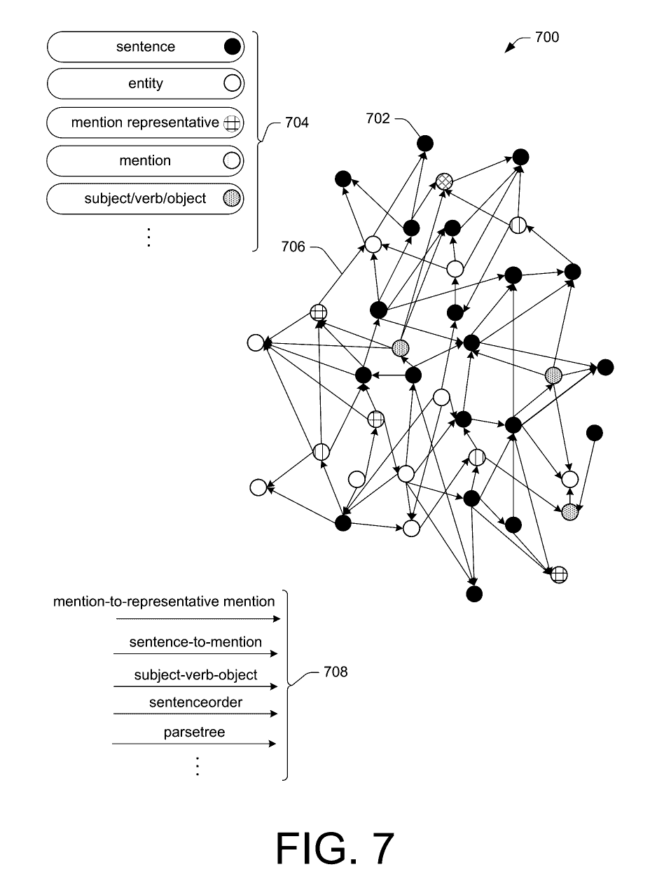

FIG. 6 illustrates an example process of creating a node graph based on NLP. In some examples, NLP techniques can identify sentence 602 or any other portion of information from a document. The NLP techniques can parse sentence 602 and identify various information and/or relationships. For instance, the NLP techniques can determine relational phrase information for sentence 602, such as subject-verb-object (SVO) triple 604 including a subject (“Hybrid car sales”), verb (“have increased about”), and object (“a percentage point”). Additionally, or alternatively, the NLP techniques can determine a parse tree (not illustrated) describing relationships between words or phrases within sentence 602. For instances, the parse tree can indicate a relationship between “sales” and “Hybrid” and another relationship between “sales” and “car.” Further, the NLP techniques can determine entity information (e.g., co-reference chains), and so on, for sentence 602 and/or other parts of the document.

Based on information from the NLP techniques, a node graph can be created for the document. The node graph can include a node (not illustrated in FIG. 6) for each token (e.g., word or phrase) identified in the document. The nodes can be related based on parse trees, entity information, and/or relational phrase information. Additional nodes can be added and/or linked to model a structure of the text. For example, node 606 can be added as a representative mention for the phrase “hybrid car sales,” representing a most descriptive sentence for such phrase in the document. Node 606 can be linked to node 608 representing another sentence that mentions the phrase “hybrid car sales.” Node 606 and/or 608 can be linked to other nodes in the node graph. Further, the node graph can include node 610 representing a mention of “late 2007.” Node 610 can be linked to node 612 representing a representative mention of node 610. Node 612 can be linked to other nodes, such as nodes that represent other mentions of “late 2007.” The linking of nodes 606 and 608 and the linking of nodes 610 and 612 can each represent a co-reference chain. As such, text within the document (e.g., entities, phrase, etc.) can be related through the node graph to model a structure of the text.

FIG. 7 illustrates an example node graph 700 for a document. Node graph 700 can comprise nodes 702. Each of nodes 702 can correspond to a token identified in the document, such as a word, phrase, sentence, etc. Each of nodes 702 is illustrated with a different type of fill to show a class from among classes 704 to which the node belongs, such as a sentence class, an entity class, a mention representative class, a mention class, a subject/verb/object class, and so on. Relationships between nodes 702 are illustrated with links 706. Such relationships can be from various classes of relationships 708. Example classes of relationships 708 include a mention-to-representative mention class representing links between a mention class node to a representative mention class node, a sentence-to-mention class representing a link between a sentence class node and a mention class node, a subject-verb-object class representing links between subjects, verbs, and objects, a sentence order class representing links between sentences based on an order of the sentences, a parse tree class representing links between nodes of a parse tree, and so on. For ease of illustration, links 706 (and corresponding classes of relationships 708) are shown in a similar manner (i.e., with solid lines).

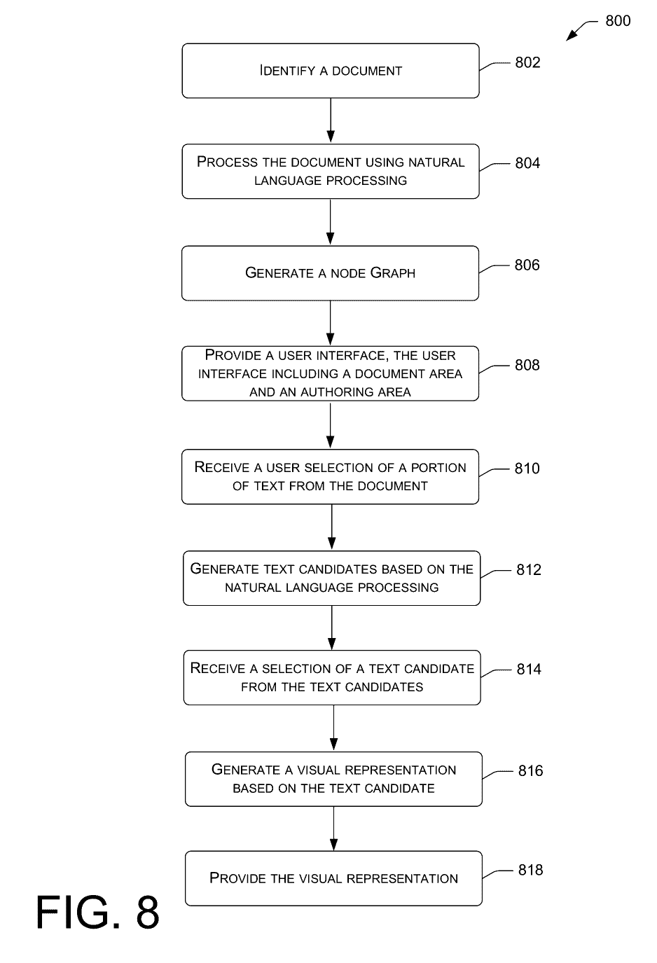

FIGS. 8-10 are flow diagrams of illustrative processes for employing the techniques described herein. One or more of the individual processes and/or operations can be performed in example environment 100 of FIG. 1. For example, one or more of the individual processes and/or operations can be performed by service provider 102 and/or device(s) 120. Moreover, environment 100 can be used to perform other processes.

The processes are illustrated as a collection of blocks in a logical flow graph, which represent a sequence of operations that can be implemented in hardware, software, or a combination thereof. The blocks are referenced by numbers. In the context of software, the blocks represent computer-executable instructions stored on one or more computer-readable media that, when executed by one or more processing units (such as hardware microprocessors), perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes. Further, any number of operations can be omitted.

FIG. 8 is a flow diagram of an example illustrative process for authoring a visual representation for a document.

At 802, a system can identify a document. In one example, the system can search though a document database to identify a document. In another example, the system can receive the document from a user device or other device (e.g., via a network). In many instances, a user can select the document for processing.

At 804, the system can process the document using natural language processing. For instance, the natural language processing can generate or determine one or more parse trees for the document using the natural language processing. A parse tree can indicate relationships between one or more words and/or phrases within a sentence of a document. Additionally, or alternatively, the natural language processing can generate entity information (e.g., a co-reference chain, output from entity recognition, etc.) indicating relationships between one or more words and/or phrases in the document that refer to a same entity. Further, the natural language processing can generate relational phrase information indicating relationships for subjects, verbs, and/or objects in the document.

At 806, the system can generate a node graph. For instance, the system can generate the node graph based at least in part on the natural language processing. To generate the node graph, the system can use one or more parse trees, entity information, relational phrase information, and/or any other information that can be provided by the natural language processing. The node graph can identify relationships between one or more words and/or phrases (e.g., identified tokens).

At 808, the system can provide a user interface. The user interface can include a document area that displays the text of the document and an authoring area that presents one or more visual representations for the document. In some instances, the system can provide the user interface by sending data associated with the user interface to a user device. In other instances, the system can provide the user interface by presenting (e.g., displaying) the user interface via a display device associated with the system. Although illustrated after operation 806, operation 808 can be performed before operation 802 and/or at any other instance. In one example, a user can select a document for processing via the user interface and then process 800 can proceed with processing the selected document.

At 810, the system can receive a user selection of a portion of text that is provided via the text area. In some instances, the system can receive the user selection based on a user hovering over the portion of the text using an input device. In other instances, the system can receive the user selection based on the user selecting the portion of the text using the input device. The input device can include a mouse, pen, finger, or the like. In some illustrations, a specialized pen can be used that includes specific buttons or other input elements that are tailored to authoring visual representations (e.g., a button to create a visual representation upon selecting text).

At 812, the system can generate text candidates based at least in part on the natural language processing. For instance, the system can identify text candidates for the selected portion of the text using the node graph and/or any information that is output by the natural language processing (e.g., parse trees, entity information, relational phrase information, etc.). Identifying text candidates can include identifying one or more words or phrases that have a relationship with the selected portion of the text. The system can then provide the text candidates to the user. In an example, providing the text candidates to the user can include providing a list of the candidates to the user via the user interface.

At 814, the system can receive a selection of a text candidate from the text candidates, and at 816, the system can generate a visual representation based on the text candidate. In one example, the visual representation can include a text box that represents the selected text candidate. In another example, the visual representation can include a graphical representation (e.g., object) that represents the selected text candidate. For instance, the graphical representation can include a chart, graph, and/or table that represents the selected test candidate. In some examples, generating a visual representation comprises identifying a first term or phrase that represents a first value, and identifying a second term or phrase that represents a second value. In some examples, a first visual representation can represent the first value with respect to the second value, where the first visual representation includes at least one of a graph, a chart, or a table. In some examples, the system can enable a user to update at least one of the first value, the second value, or an association between the first value and the second value. In various examples, the first value and/or second value can comprise a numerical value.

At 818, the system can provide the visual representation. In some examples, the system can provide the visual representation for presentation in the authoring area of the user interface.

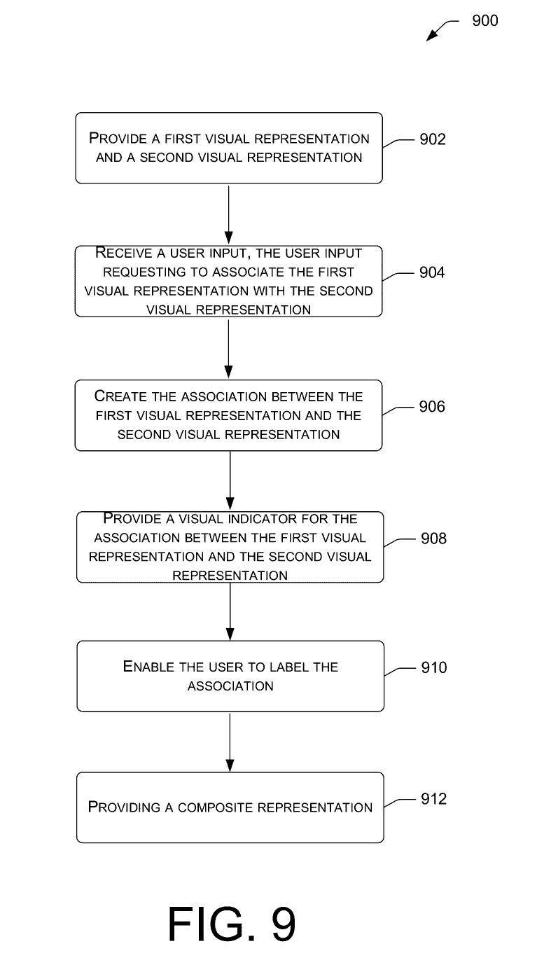

FIG. 9 is a flow diagram of an example illustrative process for associating visual representations.

At 902, the system can provide a first visual representation and a second visual representation. In some examples, the first visual representation and the second visual representation can comprise representations of a first portion of text and a second portion of text, respectively. In some examples, the system can create the first visual representation and the second visual representation upon receiving a selection of the first portion of text and the second portion of text from a document presented on a display associated with the system.

At 904, the system can receive a user input, the user input requesting to associate the first visual representation with the second visual representation. In some examples, the system can receive the user input through one or more input devices associated with the system.

At 906, the system can create an association between the first visual representation and the second visual representation. In some examples, the system can create the association based at least in part on the user input received at 904.

At 908, the system can provide a visual indicator for the association between the first visual representation and the second visual representation.

At 910, the system can enable a user to label the association between the first visual representation and the second visual representation. For example, the system can receive one or more inputs from a user and via an input device that specifies text to label the association.

At 912, the system can provide a composite representation. In some examples, the composite representation represents content of the document. For instance, the composite representation can include the first visual representation, the second visual representation, and the association.

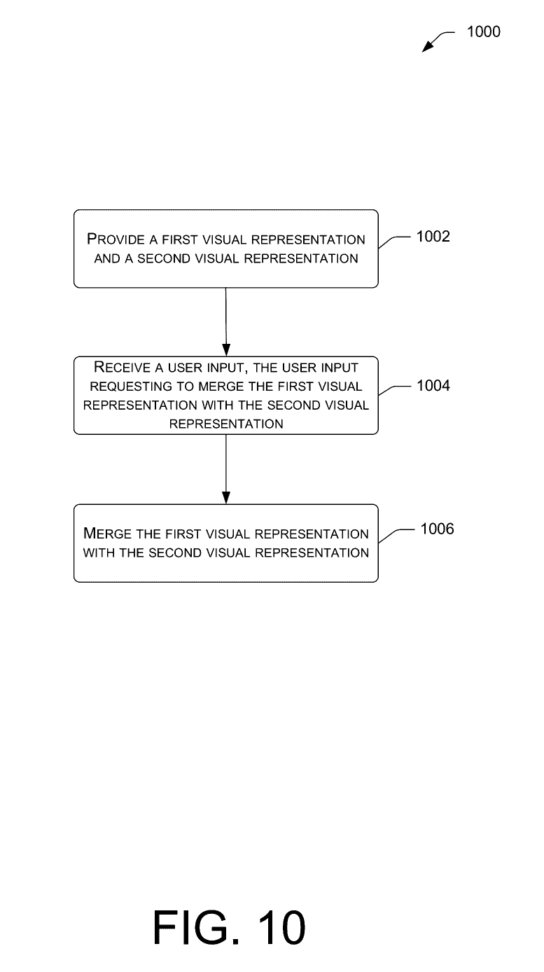

FIG. 10 is a flow diagram of an example illustrative process for merging visual representations.

At 1002, a system can provide a first visual representation and a second visual representation. In some examples, the first visual representation and the second visual representation can comprise one or more of text, a graph/chart/table, an image, or numerals located in a document.

At 1004, the system can receive a user input. The user input can request that the first visual representation be merged with the second visual representation. In some examples, the system can receive the user input through one or more input devices associated with the system.

At 1006, the system can merge the first visual representation with the second visual representation to generate a combined visual representation. In some instances where the first visual representation and/or the second visual representation include a graph/chart/table, the merging can include updating the graph/chart/table based on the combined information of the first visual representation and the second visual representation. That is, a single graph/chart/table can be presented with the combined data. Alternatively, or additionally, the merging can include representing one visual representation (or text of the visual representation) as dependent from another visual representation (or text of the other visual representation).

### Example Clauses

Example A, a system comprising: one or more processors; and memory communicatively coupled to the one or more processors and storing computer-executable instructions that, when executed by the one or more processors, cause the one or more processors to perform operations comprising: receiving a document that includes text; processing the document using natural language processing; providing a user interface, the user interface including a document area to present the text of the document and an authoring area to present one or more visual representations for the document; receiving a first selection of a first portion of the text that is presented in the document area; generating, based at least in part on the natural language processing, a first visual representation for the first portion of the text; and providing the first visual representation for presentation in the authoring area of the user interface.

Example B, the system of example A, wherein the operations further comprise: receiving a second selection of a second portion of the text that is presented in the document area; generating, based at least in part on the natural language processing, a second visual representation for the second portion of the text; providing the second visual representation for presentation in the authoring area of the user interface; receiving user input requesting to associate the second visual representation with the first visual representation; and associating the first visual representation with the second visual representation.

Example C, the system of example B, wherein the operations further comprise providing a visual indicator to indicate an association between the first visual representation and the second visual representation.

Example D, the system of any of examples A-C, wherein the operations further comprise: generating a list of text candidates for the first portion of the text based at least in part on the natural language processing; and receiving a selection of a text candidate from the list of text candidates, and wherein generating the first visual representation for the first portion of the text comprises generating a visual representation for the text candidate.

Example E, the system of any of examples A-D, wherein the processing the document includes processing the document using the natural language processing to determine at least one of a parse tree for a sentence in the document, entity information indicating a relationship between two or more words or phrases in the document that refer to a same entity, or relational phrase information indicating a relationship for a subject, verb, and object in the document.

Example F, the system of example E, wherein the operations further comprise: generating a node graph for the document based on at least one of the parse tree, the entity information, or the relational phrase information, the node graph indicating a relationship between the first portion of the text of the document and a second portion of the text or other text of the document; and generating a list of text candidates for the first portion of the text by: determining that the second portion of the text or the other text has the relationship to the first portion of the text in the node graph; and generating a text candidate for the second portion of the text; and receiving a selection of a text candidate from the list of text candidates, and wherein generating the first visual representation for the first portion of the text comprises generating a visual representation for the text candidate.

Example G, one or more computer-readable storage media storing executable instructions that, when executed by one or more processors, cause the one or more processors to perform acts comprising: presenting a document that includes text; receiving a first user selection of a first portion of the text of the document; presenting a first visual representation to represent the first portion of the text, the first visual representation being based at least in part on processing the document using natural language processing; receiving a second user selection of a second portion of the text of the document; presenting a second visual representation to represent the second portion of the text, the second visual representation being based at least in part on processing the document using natural language processing; receiving user input to associate the first visual representation with the second visual representation; based at least in part on the user input, creating an association between the first visual representation and the second visual representation; and providing the first visual representation, the second visual representation, and the association as a composite representation that represents content of the document.

Example H, the one or more computer-readable storage media of example G, wherein the acts further comprise: receiving a third user selection of the first visual representation; and presenting the first portion of the text with an annotation to indicate that the first portion of the text is associated with the first visual representation.

Example I, the one or more computer-readable storage media of example G or H, wherein the first visual representation presents at least one of the first portion of the text or an image that represents the first portion of the text.

Example J, the one or more computer-readable storage media of example I, wherein the acts further comprise: identifying (i) a first term or phrase within the first portion of the text that represents a first value and (ii) a second term or phrase that represents a second value; and generating the first visual representation, the first visual representation representing the first value with respect to the second value, the first visual representation including at least one of a graph, a chart, or a table.

Example K, the one or more computer-readable storage media of example J, wherein the acts further comprise: enabling a user to update at least one of the first value, the second value, or an association between the first value and the second value.

Example L, the one or more computer-readable storage media of any of examples G-K, wherein: the first visual representation graphically presents a first value with respect to a second value, the first value comprising a numerical value; the second visual representation graphically presents a third value with respect to a fourth value, the third value being of a same type as the first value and the fourth value being of a same type as the second value, and the acts further comprising: receiving user input to merge the first visual representation with the second visual representation; and merging the first visual representation with the second visual representation to generate a combined visual representation, the combined visual representation graphically presenting, within at least one of a same graph, chart, or table, the first value with respect to the second value and the third value with respect to the fourth value.

Example M, the one or more computer-readable storage media of any of examples G-L, wherein the acts further comprise: enabling a user to label the association between the first visual representation and the second visual representation; and wherein the providing includes providing the label as part of the composite representation.

Example N, a method comprising: identifying, by a computing device, a document; processing, by the computing device, the document using natural language processing; providing, by the computing device, a user interface, the user interface including a document area to present text of the document and an authoring area to present a visual representation for a portion of the text that is selected by a user, the visual representation being based at least in part on the natural language processing; and providing, by the computing device, the visual representation to represent content of the document.

Example O, the method of example N, wherein: the processing the document comprises processing the document using the natural language processing to determine a parse tree for a sentence that includes the portion of the text, the portion of the text comprising a first word or phrase in the sentence, the parse tree indicating a relationship between the first word or phrase within the sentence and a second word or phrase within the sentence, and the method further comprising: generating a list of text candidates for the portion of the text by: determining that the second word or phrase has the relationship to the first word or phrase in the parse tree; and based at least in part on the determining, generating a text candidate for the list of text candidates, the text candidate including the second word or phrase; and receiving user selection of the text candidate from the list of text candidates; and based at least in part on the user selection, generating the visual representation for the portion of the text, the visual representation representing the text candidate that includes the second word or phrase.

Example P, the method of example N or O, wherein: the processing the document comprises processing the document to determine entity information for the portion of the text, the entity information indicating that the portion of the text and another portion of the text refer to a same entity, and the method further comprising: generating a list of text candidates for the portion of the text by: determining that the other portion of the text refers to the same entity as the portion of the text in the entity information; and based at least in part on the determining, generating a text candidate for the list of text candidates, the text candidate including the other portion of the text; and receiving user selection of the text candidate from the list of text candidates; and based at least in part on the user selection, generating the visual representation for the portion of the text, the visual representation representing the text candidate that includes the other portion of the text.

Example Q, the method of any of examples N-P, wherein: the processing the document comprises processing the document to determine relational phrase information indicating that the portion of the text includes a relationship to at least one of a subject, verb, or object in a sentence that includes the portion of the text, and the method further comprising: generating a list of text candidates for the portion of the text by: determining that the portion of the text includes the relationship to at least one of the subject, verb, or object in the relational phrase information; and based at least in part on the determining, generating a text candidate for the list of text candidates, the text candidate including at least one of the subject, verb, or object; and receiving user selection of the text candidate from the list of text candidates; and based at least in part on the user selection, generating the visual representation for the portion of the text, the visual representation representing the text candidate that includes at least one of the subject, verb, or object.

Example R, the method of any of examples N-Q, further comprising: generating another visual representation for another portion of the text that is selected by the user; providing the other visual representation for presentation in the authoring area of the user interface; receiving user input requesting to associate the visual representation with the other visual representation; and associating the visual representation with the other visual representation.

Example S, the method of example R, further comprising: receiving user input to merge the visual representation with the other visual representation; and merging the visual representation with the other visual representation to generate a combined visual representation, the combined visual representation presenting an association between the visual representation and the other visual representation.

Example T, the method of example R or S, further comprising: enabling a user to label an association between the visual representation and the other visual representation.

### CONCLUSION

Although the techniques have been described in language specific to structural features and/or methodological acts, it is to be understood that the appended claims are not necessarily limited to the features or acts described. Rather, the features and acts are described as example implementations of such techniques.

The operations of the example processes are illustrated in individual blocks and summarized with reference to those blocks. The processes are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) 106, 120, and/or 200 such as one or more internal or external CPUs or GPUs, and/or one or more pieces of hardware logic such as FPGAs, DSPs, or other types of accelerators.

All of the methods and processes described above can be embodied in, and fully automated via, software code modules executed by one or more general purpose computers or processors. The code modules can be stored in any type of computer-readable storage medium or other computer storage device. Some or all of the methods can alternatively be embodied in specialized computer hardware.

Conditional language such as, among others, “can,” “could,” “might” or “can,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions can be deleted, or executed out of order from that shown or discussed, including substantially synchronously or in reverse order, depending on the functionality involved as would be understood by those skilled in the art. It should be emphasized that many variations and modifications can be made to the above-described examples, the elements of which are to be understood as being among other acceptable examples. All such modifications and variations are intended to be included herein within the scope of this disclosure and protected by the following claims.

What is claimed is:

1. A system comprising:
one or more processors; and
memory communicatively coupled to the one or more processors and storing computer-executable instructions that, when executed by the one or more processors, cause the one or more processors to perform operations comprising:
receiving a document that includes text;
processing the document using natural language processing;
providing a user interface, the user interface including a document area to present the text of the document and an authoring area to present one or more visual representations for the document;
receiving a first selection of a first portion of the text that is presented in the document area;
generating, based at least in part on the natural language processing, a first visual representation for the first portion of the text; and
providing the first visual representation for presentation in the authoring area of the user interface.

2. The system of claim 1, wherein the operations further comprise:
receiving a second selection of a second portion of the text that is presented in the document area;
generating, based at least in part on the natural language processing, a second visual representation for the second portion of the text;
providing the second visual representation for presentation in the authoring area of the user interface;
receiving user input requesting to associate the second visual representation with the first visual representation; and
associating the first visual representation with the second visual representation.

3. The system of claim 2, wherein the operations further comprise providing a visual indicator to indicate an association between the first visual representation and the second visual representation.

4. The system of claim 1, wherein the operations further comprise:
generating a list of text candidates for the first portion of the text based at least in part on the natural language processing; and
receiving a selection of a text candidate from the list of text candidates,
and wherein generating the first visual representation for the first portion of the text comprises generating a visual representation for the text candidate.

5. The system of claim 1, wherein the processing the document includes processing the document using the natural language processing to determine at least one of a parse tree for a sentence in the document, entity information indicating a relationship between two or more words or phrases in the document that refer to a same entity, or relational phrase information indicating a relationship for a subject, verb, and object in the document.

6. The system of claim 5, wherein the operations further comprise:
generating a node graph for the document based on at least one of the parse tree, the entity information, or the relational phrase information, the node graph indicating a relationship between the first portion of the text of the document and a second portion of the text or other text of the document; and
generating a list of text candidates for the first portion of the text by:
determining that the second portion of the text or the other text has the relationship to the first portion of the text in the node graph; and
generating a text candidate for the second portion of the text; and
receiving a selection of a text candidate from the list of text candidates,
and wherein generating the first visual representation for the first portion of the text comprises generating a visual representation for the text candidate.

7. One or more computer-readable storage media storing executable instructions that, when executed by one or more processors, cause the one or more processors to perform acts comprising:
presenting a document that includes text;
receiving a first user selection of a first portion of the text of the document;
presenting a first visual representation to represent the first portion of the text, the first visual representation being based at least in part on processing the document using natural language processing;
receiving a second user selection of a second portion of the text of the document;
presenting a second visual representation to represent the second portion of the text, the second visual representation being based at least in part on processing the document using natural language processing;
receiving user input to associate the first visual representation with the second visual representation;
based at least in part on the user input, creating an association between the first visual representation and the second visual representation; and
providing the first visual representation, the second visual representation, and the association as a composite representation that represents content of the document.

8. The one or more computer-readable storage media of claim 7, wherein the acts further comprise:
receiving a third user selection of the first visual representation; and
presenting the first portion of the text with an annotation to indicate that the first portion of the text is associated with the first visual representation.

9. The one or more computer-readable storage media of claim 7, wherein the first visual representation presents at least one of the first portion of the text or an image that represents the first portion of the text.

10. The one or more computer-readable storage media of claim 9, wherein the acts further comprise:
identifying (i) a first term or phrase within the first portion of the text that represents a first value and (ii) a second term or phrase that represents a second value; and
generating the first visual representation, the first visual representation representing the first value with respect to the second value, the first visual representation including at least one of a graph, a chart, or a table.

11. The one or more computer-readable storage media of claim 10, wherein the acts further comprise:
enabling a user to update at least one of the first value, the second value, or an association between the first value and the second value.

12. The one or more computer-readable storage media of claim 7, wherein:
the first visual representation graphically presents a first value with respect to a second value, the first value comprising a numerical value;
the second visual representation graphically presents a third value with respect to a fourth value, the third value being of a same type as the first value and the fourth value being of a same type as the second value, and the acts further comprising:
receiving user input to merge the first visual representation with the second visual representation; and
merging the first visual representation with the second visual representation to generate a combined visual representation, the combined visual representation graphically presenting, within at least one of a same graph, chart, or table, the first value with respect to the second value and the third value with respect to the fourth value.

13. The one or more computer-readable storage media of claim 7, wherein the acts further comprise:
enabling a user to label the association between the first visual representation and the second visual representation;
and wherein the providing includes providing the label as part of the composite representation.

14. A method comprising:
identifying, by a computing device, a document;
processing, by the computing device, the document using natural language processing;
providing, by the computing device, a user interface, the user interface including a document area to present text of the document and an authoring area to present a visual representation for a portion of the text that is selected by a user, the visual representation being based at least in part on the natural language processing; and
providing, by the computing device, the visual representation to represent content of the document.

15. The method of claim 14, wherein:
the processing the document comprises processing the document using the natural language processing to determine a parse tree for a sentence that includes the portion of the text, the portion of the text comprising a first word or phrase in the sentence, the parse tree indicating a relationship between the first word or phrase within the sentence and a second word or phrase within the sentence, and the method further comprising:
generating a list of text candidates for the portion of the text by:
determining that the second word or phrase has the relationship to the first word or phrase in the parse tree; and
based at least in part on the determining, generating a text candidate for the list of text candidates, the text candidate including the second word or phrase; and
receiving user selection of the text candidate from the list of text candidates; and
based at least in part on the user selection, generating the visual representation for the portion of the text, the visual representation representing the text candidate that includes the second word or phrase.

16. The method of claim 14, wherein:
the processing the document comprises processing the document to determine entity information for the portion of the text, the entity information indicating that the portion of the text and another portion of the text refer to a same entity, and the method further comprising:
generating a list of text candidates for the portion of the text by:
determining that the other portion of the text refers to the same entity as the portion of the text in the entity information; and
based at least in part on the determining, generating a text candidate for the list of text candidates, the text candidate including the other portion of the text; and
receiving user selection of the text candidate from the list of text candidates; and
based at least in part on the user selection, generating the visual representation for the portion of the text, the visual representation representing the text candidate that includes the other portion of the text.

17. The method of claim 14, wherein:
the processing the document comprises processing the document to determine relational phrase information indicating that the portion of the text includes a relationship to at least one of a subject, verb, or object in a sentence that includes the portion of the text, and the method further comprising:
generating a list of text candidates for the portion of the text by:
determining that the portion of the text includes the relationship to at least one of the subject, verb, or object in the relational phrase information; and
based at least in part on the determining, generating a text candidate for the list of text candidates, the text candidate including at least one of the subject, verb, or object; and
receiving user selection of the text candidate from the list of text candidates; and
based at least in part on the user selection, generating the visual representation for the portion of the text, the visual representation representing the text candidate that includes at least one of the subject, verb, or object.

18. The method of claim 14, further comprising:
generating another visual representation for another portion of the text that is selected by the user;
providing the other visual representation for presentation in the authoring area of the user interface;
receiving user input requesting to associate the visual representation with the other visual representation; and
associating the visual representation with the other visual representation.

19. The method of claim 18, further comprising:
receiving user input to merge the visual representation with the other visual representation; and
merging the visual representation with the other visual representation to generate a combined visual representation, the combined visual representation presenting an association between the visual representation and the other visual representation.

20. The method of claim 18, further comprising:
enabling a user to label an association between the visual representation and the other visual representation.
